(19) United States
(12) Patent Application Publication
(10) Pub. No.: US 2005/0149334 A1
(43) Pub. Date: Jul. 7, 2005

(54) Digital camera module with controlled disabling

(75) Inventor: Ga-Lane Chen, Fremont, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-cheng City (TW)

(21) Appl. No.: 10/892,061

(22) Filed: Jul. 15, 2004

(30) Foreign Application Priority Data
Jan. 2, 2004 (TW) 093200032

(51) Int. Cl. G10L 11/00

(52) U.S. Cl. 704/275

(57) ABSTRACT

A digital camera module 100) for a portable electronic device includes an image-obtaining device 20) for obtaining images, and a controlling device 10). The image-obtaining device includes a printed circuit board 204) with an image sensor 206) attached thereon. The controlling device includes a microphone 102) for receiving an incoming voice, a voice recognition module 104) electrically connected with the microphone for recognizing predetermined voice inputs, and a power source 202) providing electrical energy to the printed circuit board, the microphone and the voice recognition module. The controlling device controls power supplied to the image-obtaining device when the voice recognition module recognizes a voice input such as “don't take a picture.”

### BACKGROUND OF THE INVENTION

1. Field of the Invention

The present invention generally relates to digital camera modules, and more particularly to a digital camera module which is used in portable electronic devices such as digital cameras and video cameras.

2. Prior Art

Currently, digital camera modules are being widely used in a variety of portable electronic devices. Most portable electronic devices are becoming progressively more miniaturized over time, and digital camera modules are correspondingly becoming smaller and smaller. For example, digital camera modules are now widely available as a feature of a mobile phone. However, the small size of a contemporary digital camera module makes it easy for a user to surreptitiously take photographs. Members of the public and indeed users themselves are concerned about the potential loss of privacy and personal offense that can result from such use. Yet because of the small size of the digital camera module, it is difficult for people to be vigilant of potential misuse of the corresponding portable electronic device.

Therefore, a digital camera module that can help prevent untoward use thereof is desired.

### SUMMARY OF THE INVENTION

Accordingly, an object of the present invention is to provide a digital camera module which can help prevent misuse thereof.

To achieve the above-mentioned object, a digital camera module for a portable electronic device includes an image-obtaining device for obtaining images, and a controlling device. The image-obtaining device includes a printed circuit board with an image sensor attached thereon. The controlling device includes a microphone for receiving an incoming voice, a voice recognition module electrically connected with the microphone for recognizing predetermined voice inputs, and a power source providing electrical energy to the printed circuit board, the microphone and the voice recognition module. The controlling device controls power supplied to the image-obtaining device when the voice recognition module recognizes a voice input such as “don't take a picture.”

Other objects, advantages and novel features of the invention will become more apparent from the following detailed description when taken in conjunction with the accompanying drawings, in which:

### BRIEF DESCRIPTION OF THE DRAWINGS

FIG. 1 is a schematic diagram of electrical and physical relationships between components of a digital camera module in accordance with a first preferred embodiment of the present invention; and

FIG. 2 is a schematic diagram of electrical and physical relationships between components of a digital camera module in accordance with a second preferred embodiment of the present invention.

### DETAILED DESCRIPTION OF THE INVENTION

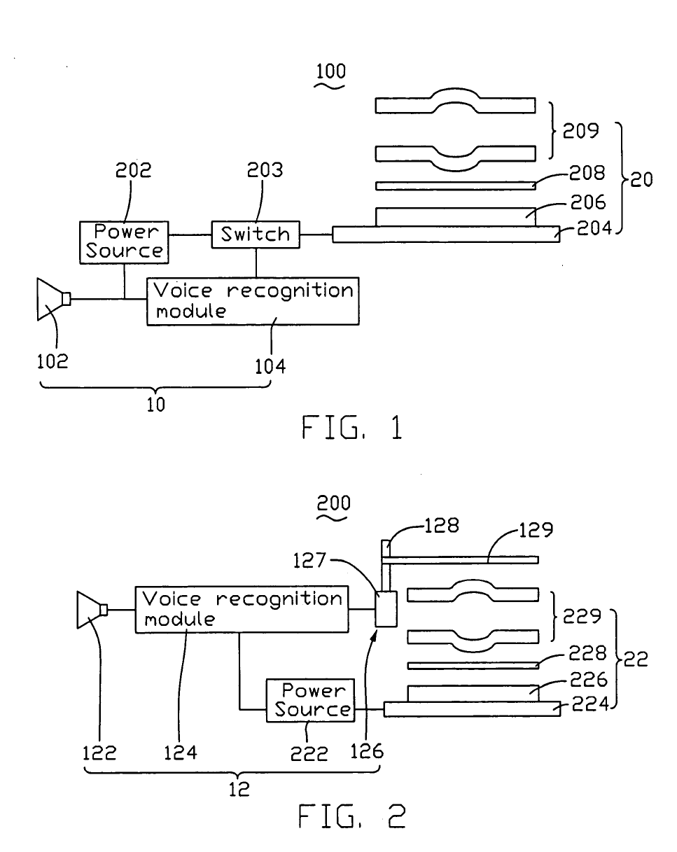

Referring to FIG. 1, a digital camera module 100 used in a portable electronic device in accordance with the first preferred embodiment of the present invention includes an image-obtaining device 20 and a controlling device 10. The controlling device 10 is electrically connected with the image-obtaining device 20.

The image-obtaining device 20 includes a printed circuit board 204, an image sensor 206, a filter 208, and a lens 209. More than one lens 209 may be provided if desired. The image sensor 206 comprises a CCD (Charge Coupled Device) or a CMOS (Complementary Metal Oxide Semiconductor), and is attached on the printed circuit board 204 for transforming optical signals into electronic signals. The lens 209 is provided in front of the image sensor 206. The filter 208 is provided between the lens 209 and the image sensor 206, for reducing the amount of red light that reaches the image sensor 206. It is to be understood that, in practice, the image-obtaining device 20 can also be provided with other suitable structures.

The controlling device 10 includes a microphone 102, a voice recognition module 104, a power source 202, and a switch 203. The microphone 102 can be similar to a typical microphone employed in a mobile phone. The voice recognition module 104 is electrically connected with both the microphone 102 and the switch 203. The voice recognition module 104 is used for recognizing predetermined voice inputs, and sending instructions to the switch 203 according to recognized voice inputs. The power source 202 is connected in parallel with the voice recognition module 104; that is, the power source 202 is also electrically connected with both the microphone 102 and the switch 203. The power source 202 provides electrical energy to the microphone 102, the voice recognition module 104 and the printed circuit board 204 through the switch 203. The switch 203 is closed under normal conditions.

In use, when the microphone 102 receives a predetermined voice command, for example “don't take a picture,” the controlling device 10 is actuated to operate according to the command. The input voice command is first transmitted to the voice recognition module 124. The voice recognition module 104 recognizes the input voice command, and sends out an instruction to open the switch 203. When the switch is opened, the image-obtaining device 20 is unable to receive electrical energy, and the photo-taking function of the camera module 100 cannot operate.

Referring also to FIG. 2, a camera module 200 used in a portable electronic device in accordance with the second preferred embodiment of the present invention includes an image-obtaining device 22 and a controlling device 12. The controlling device 12 is electrically connected with the image-obtaining device 20.

The image-obtaining device 22 has a similar structure to that of the image-obtaining device 20 of the first embodiment. The image-obtaining device 22 includes a printed circuit board 224, an image sensor 226, a filter 228, and a lens 229. More than one lens 229 may be provided if desired. The image sensor 226 comprises a CCD or a CMOS, and is attached on the printed circuit board 224 for transforming optical signals into electronic signals. The lens 229 is provided in front of the image sensor 226. The filter 228 is provided between the lens 229 and the image sensor 226, for reducing the amount of red light that reaches the image sensor 226. It is to be understood that, in practice, the image-obtaining device 22 can also be provided with other suitable structures.

The controlling device 12 includes a microphone 122, a voice recognition module 124, a power source 222, and a shielding apparatus 126. The microphone 122 can be similar to a typical microphone employed in a mobile phone. The voice recognition module 124 is electrically connected with both the microphone 122 and shielding apparatus 126. The voice recognition module 124 is used for recognizing predetermined voice inputs, and sending instructions to the shielding apparatus 126 according to recognized voice inputs. The power source 222 is electrically connected with the voice recognition module 124 and the printed circuit board 224, for providing electrical energy thereto. The shielding apparatus 126 includes a motor 127, an arbor 128, and a covering 129. The motor 127 is electrically connected with the voice recognition module 124. One end of the arbor 128 is rotatably mounted on the motor 127, and an opposite end of the arbor 128 is attached to the covering 129. The covering 129 does not cover the image-obtaining device 22 under normal conditions. However, when the motor 127 is activated, the arbor 128 is rotated so that the covering 129 covers the image-obtaining device 22.

In use, when the microphone 122 receives a predetermined voice command, for example “don't take a picture,” the controlling device 12 is actuated to operate according to the command. The input voice command is first transmitted to the voice recognition module 124. The voice recognition module 124 recognizes the input voice command, and sends out a corresponding instruction to the shielding apparatus 126. The motor 127 is activated, and rotates the arbor 128. The arbor 128 rotates the covering 129 until the covering 129 covers the image-obtaining device 22. In this position, virtually no incoming light can reach the image-obtaining device 22. Thus the photo-taking function of the camera module 100 is ineffectual.

It is to be understood that, in both preferred embodiments, an adjustable timer (not shown) can be provided in the voice recognition module 104, 124. Once an instruction according to a recognized voice input is sent out by the voice recognition module 104, 124, the adjustable timer begins to count the number of seconds elapsed from such time. When the adjustable timer reaches a predetermined threshold count, the voice recognition module 104, 124 automatically sends out a default instruction. The image-obtaining device 20, 22 thereupon returns to its normal state.

Unlike currently known digital camera modules, the digital camera module 100, 200 of the present invention helps prevent misuse thereof. When a predetermined voice input is recognized by the voice recognition module 104, 124, the image-obtaining device 20, 22 is disabled. Further, by employing an adjustable timer, the image-obtaining device 20, 22 can be automatically re-enabled.

It is believed that the present invention and its advantages will be understood from the foregoing description, and it will be apparent that various changes may be made thereto without departing from the spirit and scope of the invention or sacrificing all of its material advantages. The examples hereinbefore described are merely preferred or exemplary embodiments of the invention.

1. A camera module for a portable electronic device, comprising:
an image-obtaining device for obtaining images, comprising a printed circuit board with an image sensor attached thereon; and
a controlling device, comprising a microphone for receiving an incoming voice, a voice recognition module electrically connected with said microphone for recognizing one or more predetermined voice inputs, and a power source providing electrical energy to said printed circuit board, said microphone and said voice recognition module;
whereby said controlling device controls said image-obtaining device if said voice recognition module recognizes a voice input.

2. The camera module as claimed in claim 1, wherein said controlling device further comprises a switch, said voice recognition module is electrically connected with said switch, and said power source is electrically connected with both said microphone and said switch and provides electrical energy to said printed circuit board through said switch, and when a voice input is recognized by said voice recognition module, said switch is opened to disable said image sensor.

3. The camera module as claimed in claim 2, wherein said voice recognition module comprises an adjustable timer, said adjustable timer counts a time from when an instruction to open said switch is sent by said voice recognition module, and when said adjustable timer reaches a predetermined time threshold, said voice recognition module sends a default instruction to re-enable said image sensor.

4. The camera module as claimed in claim 1, wherein said controlling device further comprises a shielding apparatus, and said voice recognition module is electrically connected with both said microphone and said shielding apparatus, and said power source is electrically connected with both said voice recognition module and said image-obtaining device.

5. The camera module as claimed in claim 4, wherein said shielding apparatus comprises a motor, an arbor and a covering, said motor is electrically connected with said voice recognition module, said arbor is rotatably mounted on said motor and attached to said covering, and said covering is rotated by said arbor when said motor is enabled.

6. The camera module as claimed in claim 5, wherein said voice recognition module comprises an adjustable timer, said adjustable timer counts a time from when an instruction to said motor is sent by said voice recognition module according to a recognized voice input, and when said adjustable timer reaches a predetermined time threshold, said voice recognition module sends a default instruction to said motor to rotate said covering back to an original position thereof.
